(19) United States
(12) Patent Application Publication
(10) Pub. No.: US 2009/0217092 A1
(43) Pub. Date: Aug. 27, 2009

(54) Method and Device for Controlling a Computer System Having At Least Two Execution Units and One Comparator Unit

(76) Inventors: Reinhard Weiberle, Vaihingen/Enz (DE); Bernd Mueller, Leonberg-Silberberg (DE); Rainer Gmehlich, Ditzingen (DE)

Correspondence Address: KENYON & KENYON LLP, ONE BROADWAY, NEW YORK, NY, 10004, US

(21) Appl. No.: 11/990,251

(22) PCT Filed: Jul. 26, 2006
(86) PCT No.: PCT/EP2006/064690

§ 371 Date: Mar. 5, 2009

(30) Foreign Application Priority Data
Aug. 8, 2005 (DE) 102005037246.5

(51) Int. Cl. G06F 11/07

(52) U.S. Cl. 714/24; 714/48; 714/E11.024; 714/E11.023

(57) ABSTRACT

A method for controlling a computer system having at least two execution units and one comparator unit, which system is operated in the lock-step mode and in which the results of the at least two execution units are compared, wherein when or after an error is detected by the comparator unit, an error-detection mechanism is processed on at least one execution unit for this execution unit.

### FIELD OF THE INVENTION

The present invention relates to a device and a method for maintaining a system function in the event of errors in a processor system having two cores as well as a corresponding processor system.

### BACKGROUND INFORMATION

Redundancies, for example, of microcontrollers (μC), but also of components of a μC, such as, for example, the CPU (central processing unit), for the purpose of error detection are known from the related art. In this context, redundantly calculated data and redundantly generated signals are compared for consistency by a comparator unit.

A microcontroller having redundant CPUs is also called a dual-core microcontroller (dual-core μC). In a dual-core μC, both CPUs are able to operate synchronously, that is, in parallel (in lockstep mode) or in a manner that is time-delayed by a few clock cycles. Both CPUs receive the same input data and process the same program or the same instructions. If an error exists in one of the redundantly implemented cores, which error has an effect on at least one output signal of this core, then this results in a discrepancy of the data to be compared, which discrepancy is detected by the comparator unit. In this context, in addition to “data out” data, output signals may also include the instruction address and the control signals. When a discrepancy is detected in the signals to be compared, the comparator unit generates a status or an error signal with which the comparison result may be signaled externally. However, without additional error-detection mechanisms for the redundantly implemented units, it is neither possible to locate the faulty component, nor is it possible to determine the type of cause of the error.

When the redundancies described above are used in safety-related control and regulation systems, then usually a switchover to a “secure state” of the entire system occurs after a discrepancy in the redundantly determined signals is detected, even when the cause of the discrepancy was a transient error having only a brief active duration. In automobile systems, such as, for example, an ESP system, the “secure state” usually means that the system is shut down.

Due to the fact that semiconductor structures are becoming smaller and smaller, an increase in transient processor errors is expected, which are caused e.g. by cosmic radiation. In order to be able to handle transient errors such that it is possible to refrain from shutting down the system and to tolerate or even “heal” errors in operation, there are already a number of solutions in the related art: Using mostly complicated methods, errors are detected by application-specific, frequently model-based plausibilizations; where necessary, a reset of the computer system is triggered. The computer system re-initializes itself and is, after the initialization time and an optional “recovery check” (after, for example, a few 100 ms) operational once again (so-called “forward recovery”).

For applications that are not real-time-capable (for example, transactions at financial markets), a state is formed in an application-specific way before the transaction, which is stored and discarded as invalid only after a confirmed successful conclusion to the transaction exists. When errors occur during the transaction, the system jumps back to the stored starting point (“backward recovery”). In real-time systems, such solutions are very complicated, and usually function is interrupted for the duration of a reset or a recovery check of the processor system.

With an increasing range of functions of electronic regulating systems in a vehicle, a shutdown of a system, such as ESP with steering intervention, does not constitute a transition to a secure system state in every operating state.

### SUMMARY OF THE INVENTION

An objective of the present invention is a method for operating a dual-core processor (or a dual-processor system) with the aim of an increased robustness with regard to errors and an increased (partial) availability of the system function when transient and permanent errors occur in the processor system. In an advantageous exemplary embodiment, this may be achieved while maintaining the original execution time for the individual program segments.

In a dual-core computer according to the related art that is operated in the lockstep mode, one CPU operates as master and a second CPU operates as slave. The results of the slave CPU are utilized only for comparing the results of the master CPU. Only the master CPU may write results to the data/address bus or into CPU registers.

The advantages of the present invention include alternating assignment of the master function to the at least two execution units and thus the alternating use of the core results of a dual-core or multi-core computer that is operated in the lockstep mode. Thus, when certain boundary conditions are taken into account, a restricted operation of the processor system may be maintained even after a discrepancy in the redundantly calculated results has been detected. This is advantageous particularly in real-time applications in which a shutdown of the system due to processor errors is not desired in every operating state.

In an exemplary embodiment, an additional advantage results from the fact that an error in the execution units of the processor system is able to be located, that the faulty execution unit is deactivated, and that the system having the non-faulty execution unit continues to operate until a system state is reached that is not critical for shutdown or a previously specified maximum operating time in this mode is exceeded.

A method for controlling a computer system having at least two execution units and one comparator unit is advantageously described, which system is operated in the lock-step mode and in which the results of the at least two execution units are compared, wherein when or after an error is detected by the comparator unit, an error-detection mechanism is processed on at least one execution unit for this execution unit. A method is advantageously described, wherein when or after an error is detected by the comparator unit, the current instruction sequence on the at least two execution units is terminated and an error-detection mechanism is processed on the at least two execution units. A method is advantageously described, wherein when or after an error is detected by the comparator unit, the current instruction sequence is terminated on exactly one execution unit, on this one execution unit an error-detection mechanism is processed, the comparator unit of the at least two execution units is switched off for the duration of the processing of the error-detection mechanism, and on the at least one other execution unit the normal program sequence is processed further.

A method is advantageously described wherein after processing of the error-detection mechanism, the normal program sequence is continued if the error-detection mechanisms have not detected any error. A method is advantageously described, wherein when or after an error is located on an execution unit, the faulty execution unit is shut down. A method is advantageously described, wherein the comparator unit is deactivated. A method is advantageously described, wherein when at least one component is deactivated, an error signal is generated, which is provided to the application. A method is advantageously described, wherein after an error occurs, the operation using only one execution unit is restricted temporally and the computer system is shut down at the latest after a previously specified time has passed. A method is advantageously described, wherein the shutdown is already shut down by a signal generated by the application before a previously specified time has passed.

A device for controlling a computer system having at least two execution units and one comparator unit is advantageously described, which system is operated in the lock-step mode and in which the results of the at least two execution units are compared, wherein an arrangement provides that when or after an error is detected by the comparator unit, an error-detection mechanism is processed on at least one execution unit for this execution unit. A device is advantageously described, wherein an arrangement is provided to cancel the coupling of the lock step of the at least two execution units and to assign the master function to one execution unit at will. A device is advantageously described, wherein an arrangement stores an error-detection mechanism for the execution units. A device is advantageously described, wherein an arrangement supplies to at least one execution unit instructions and/or the program for the error-detection mechanism when required. A device is advantageously described, wherein an arrangement deactivates the comparison unit.

Other advantages and advantageous embodiments are derived from the features described herein of the specification, including the figures.

### BRIEF DESCRIPTION OF THE DRAWINGS

FIG. 1 shows a dual-core processor having a master CPU and a slave CPU.

FIG. 2 shows a dual-core processor having two system interfaces.

FIG. 3 shows a dual-core processor having an additional input signal of the comparator unit.

FIG. 4 shows a dual-core processor having an additional error signal of the comparator unit.

FIG. 5 shows a first method for error handling in a processor system with the aid of a flow chart.

FIG. 6 shows a second method for error handling in a processor system with the aid of a flow chart.

### DETAILED DESCRIPTION

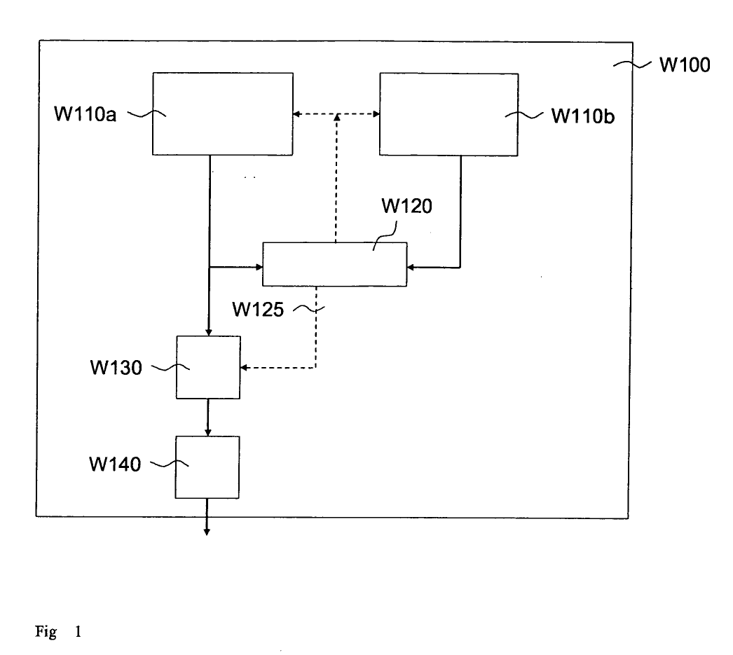

FIG. 1 shows a processor system W100 having multiple execution units W110a, W110b, for example, a dual-core computer and a comparator unit W120 that may be implemented in hardware. This processor system is operated in the lockstep mode. In this operating mode, the results of the execution units are compared, which may be after each clock cycle. In this context, an execution unit may be implemented both as a processor/core/CPU and as an FPU (floating point unit), DSP (digital signal processor), co-processor, or ALU (arithmetic logical unit), in each case having any number of assigned register records. In this context, exactly one execution unit is connected via an interruption or enabling unit W130 to a system interface W140 or directly to the data/address bus of the processor system. This execution unit is the only one to generate results that are further processed in the processor system. Therefore, the execution unit connected to system interface W130 or to the data/address bus of the processor system is designated as master. The output signals of the at least one additional execution unit are conducted only to the comparator unit W120 and are used there for plausibilization of the output signals of the master. Comparator unit W120 controls interruption and enabling unit W130 via signal W125, which constitutes an item of information representing the comparison. Such a system having exactly two execution units that are implemented as CPUs is known from the related art as a dual-core microcontroller.

In contrast to a known dual-core microcontroller that is operated in the lockstep mode, in a first exemplary embodiment of the present invention, when certain boundary conditions are met, a value is written to a register or a memory or outputted to the data/address bus even when a discrepancy exists between the output signals of the redundant execution units. In this instance, however, the master function is not assigned permanently to one execution unit, but rather may be assigned to different execution units. This assignment may occur according to a statically determined scheme or may be specified dynamically.

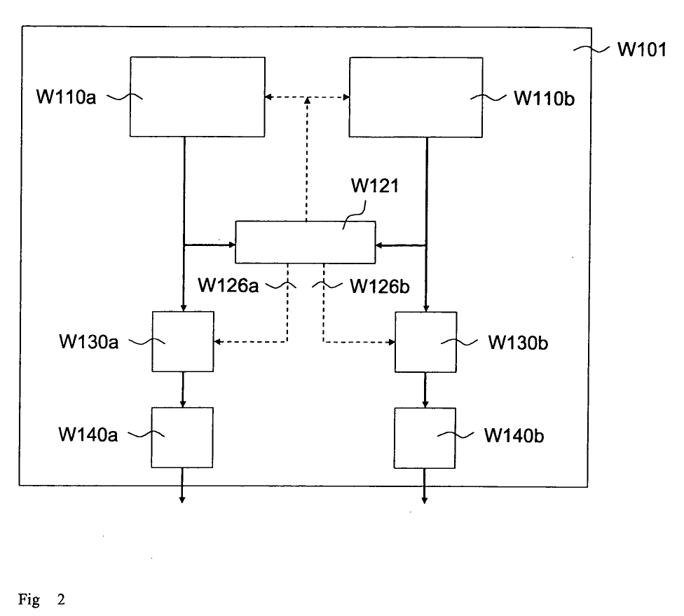

In a second exemplary embodiment shown in FIG. 2, processor system W101 contains a comparator unit W121 that is extended relative to processor system W100 shown in FIG. 1, two interruption or enabling units W130a, W130b, via which execution units W110a, W110b may be connected to system interfaces W140a, W140b or to the data/address bus, and that are triggered by the comparator unit via signals W126a, W126b. In this instance, it is always the case that the master function may be assigned to only one execution unit in the entire processor system, that is, it is always the case that only a maximum of one execution unit may be connected to a system interface or to the data/address bus. The assignment of the master function or the switchover of the master function occurs via the control of the interruption and enabling units W130a, W130b. These are triggered by comparator unit W121 as a function of the comparison result of the output signals of the at least two execution units.

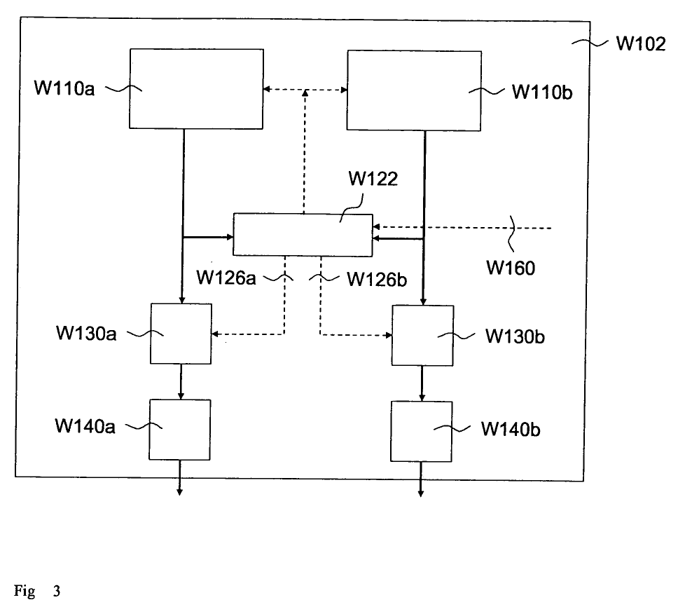

In a third exemplary embodiment shown in FIG. 3, the switchover of the master function is carried out by comparator unit W122, which switches over the master function between the at least two execution units W110a, W110b as a function of at least one input signal W160, or one identification of this input signal, via the triggering of interruption and enabling units W130a, W130b via signals W126a and W126b respectively, or it shuts down the system.

Input signal W160 or an identification of the same may be generated as a function of the time or an instruction counter (for example, every 10 clock cycles or every 10 instructions), which may be by a specific hardware component, or may be generated by the operating system, for example, as a function of the scheduling of the runtime objects (for example, a switchover may occur each time that a runtime object is called or during each operating system cycle), or may be a function of an identification in the program code, or may be generated by an interrupt or a signal of an interruption request unit, or may be a function of the access to a particular memory area in the program memory and/or data memory.

An assignment or a switchover of the master function may be a function of one of the previously mentioned conditions, a function of the comparison result of comparator unit W122, or of a combination of several of these conditions.

When there is a discrepancy among the output signals of the execution units, the comparator unit generates an internal error signal. Instead of a shutdown of the system, a switchover of the master function from one execution unit to the other execution unit may take place as a function of the system status, which is communicated to the comparator unit via signal W160. For each additional discrepancy of the output signals, this process is repeated, that is, the master function is assigned to the respectively other execution unit. It must be noted that the master relays its results, regardless of the result of a comparison, via the respective system interface W140. The comparator unit only detects a difference, but does not prevent the respective master from writing. Additional structure may now be contained in comparator unit W122 that shut down the system as a function of an error counter that counts the detected discrepancies after a specifiable number of errors is exceeded.

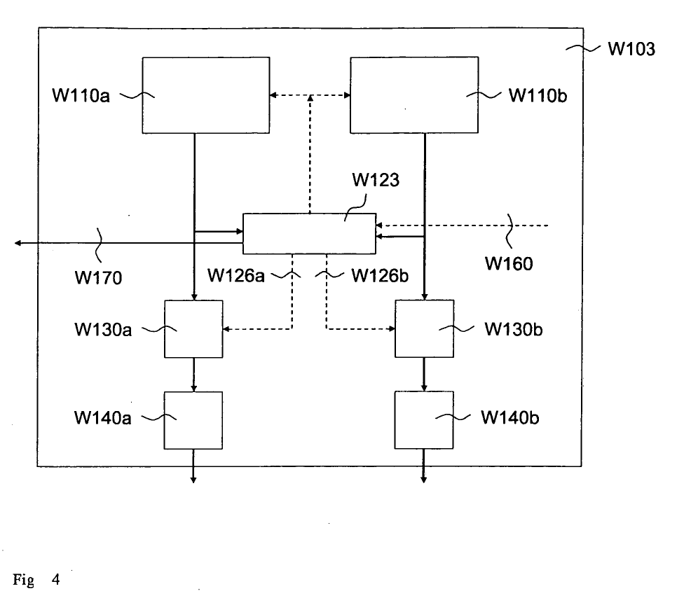

This system may also generate, as shown in FIG. 4, an external error signal W170 via comparator unit W123. This error signal may be evaluated in external units, in the operating system, or in the application, and it may be communicated to comparator unit W123 via signal W160 that the system is to be shut down. These specific embodiments have in common that when an error occurs, the processor system is thus not immediately switched off, but rather continues operating. The switchover of the master function makes it possible for at least every second result to be correct even when a permanent error occurs in one of the execution units. Depending on the application function, this may be sufficient to be able to continue to operate a system for a certain time with sufficient functional quality.

Many functions for signal conditioning and for regulating mechatronic systems in motor vehicles have a robust design, that is, short-term disturbances (for example, by EMC irradiation or by the influence of disturbance variables in a control loop) do not have safety-critical effects in such systems and may thus be tolerated. Longer lasting disturbances, however, are not tolerated even by such “robust” systems. For such robust functions, the processor system does not have to be shut down immediately after an error occurs, that is, after a discrepancy has been detected by the comparator unit. When the cause of the error is transient and has a short active duration, the error usually no longer exists when the next call is carried out. When the output signals of the execution units are used in an alternating fashion or when the assignment of the master functions alternates in a processor system having multiple execution units, even a permanent error in one of the execution units does not have a lasting influence on the application, but rather influences it only intermittently. Thus, when an error occurs, it is possible to hold off on shutting down the processor system until an error is detected unequivocally as a permanent error or a system state of the application system is reached that is appropriate for a shutdown.

In an additional exemplary embodiment, when a discrepancy is detected among the output signals of the at least two execution units, the processing of the current instruction sequence (program block, task) is aborted on all execution units. Instead of the aborted instruction sequence, error-detection routines, such as, for example, a BIST (built-in self test) or a software-based self test, are processed in all execution units. An error may be detected and located by comparing the results of the error-detection routines to stored reference values. When an error is detected and located, the faulty execution unit is shut down. The non-faulty unit continues to operate until a system state is reached that is safe for a shutdown. A shutdown of a faulty execution unit may occur in that the comparator unit is deactivated and interruption or release unit W130a or W130b assigned to this execution unit does not allow a connection between this execution unit and the system interface or the address/data bus, or in that no instructions, data and/or clock signals are supplied to this execution unit.

There are different options for deactivating the comparator units. On the one hand, a signal may be carried to the comparator unit, which signal activates or deactivates the comparator logic or comparator function. To this end, an additional logic must be inserted in the comparator, which logic is able to execute an activation or deactivation of the comparator function as a function of such a signal. Another possibility is not to supply any data to be compared to the comparator unit. A third possibility is to ignore at the system level error signal W170 of comparator unit W123 as shown in FIG. 4, to interrupt error signal W170 itself, or not to utilize the comparison result in this case for generating control signals, such as, for example, signals W126a and W126b from FIG. 2 and FIG. 3. What all of the options have in common is that they generate a state in the system in which it does not matter if the output signals of the execution units differ. If this state is achieved by a measure in the comparator or its input or output signals, then the comparator is described as passive or deactivated.

If no error is found in the execution units when processing error-detection mechanisms, the next task is started in the lock step. If a discrepancy of the output signals is detected again, the procedure described above is carried out again; however, the number n of repetitions must be limited. The limitation may take place as a function of the error tolerance time of the application. If an error is detected again after n-fold repetitions, the system is shut down immediately.

Another exemplary embodiment as shown in FIG. 4 is based on a processor system having a dual-core architecture and a comparator unit that may be implemented in hardware, which enables, in addition to the lock-step operating mode, at least one second operating mode in which the two execution units W110a, W110b process different programs, program segments, or instructions at the same time. If the processor system is operating in the lockstep operating mode and if the comparator ascertains a discrepancy in the results, then in the execution unit in the example, W110b, which at this time is not connected to the system interface or the data/address bus, the execution of the current program segment or runtime object (called a “task” in the following) is aborted and an error-detection routine (e.g. BIST) is started. The other execution unit in the example, W110a, continues processing the current task; it does so, however, with a statistical probability of error of 50%. If the error-detection routine on W110b detects an error in W110b before the conclusion of the task running on W110a (for example, through a comparison with stored reference values), then W110b is shut down, and W110a continues to operate in a single mode (without comparison or with a deactivated comparator unit) until the overall system has reached a state that is not critical for shutdown. Then the microprocessor system is shut down. If W110b does not detect an error before the conclusion of the task of W110a, the next task is started again in lockstep; this time, however, W110b is connected to the system interface or the data/address bus. If there is no longer any discrepancy, then there is a high probability that the discrepancy in the preceding task was the result of a transient error. If a discrepancy occurs again, then this time the current task is aborted in execution unit W110a, and an error-detection routine (for example, BIST) is started. This procedure is repeated until the beginning of the next (or in a configurable number of) dispatcher round(s) (operating system cycle). If a discrepancy of the results still exists then, although no error was located, a permanent error may be inferred that was not located by the error-detection mechanisms, and the microprocessor system is shut down completely.

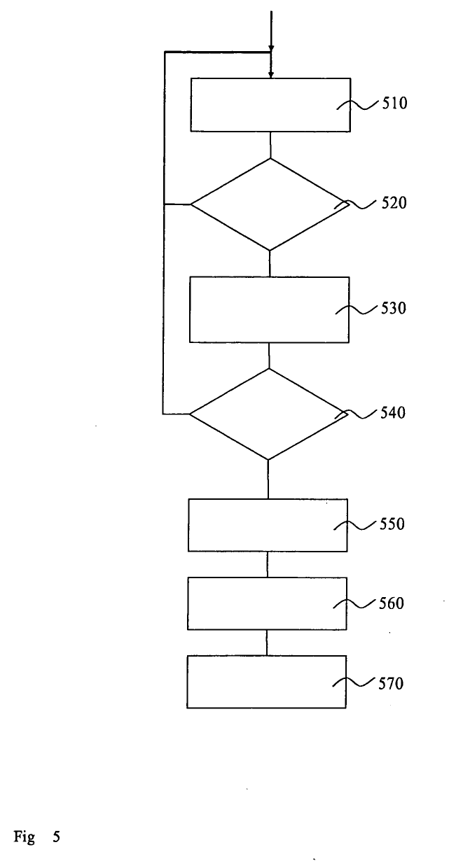

In FIG. 5, such a first method for controlling a processor system after the occurrence of a discrepancy among the output signals of the execution units is described by way of example.

In step 510, the same instructions or program segments are processed in at least two execution units.

In step 520, the output signals of these at least two execution units are compared for consistency. If the output signals are identical or within a defined tolerance range, step 510 is restarted, this time with new program segments or instructions and/or data. If a discrepancy of the output signals is detected in step 520, step 530 is executed next.

In step 530, the current program processing is interrupted, and an error-detection routine is executed on all execution units. In the process, the connection of the execution unit to the system interface or the data/address bus must be interrupted.

In step 540, the results of the error-detection routines are each compared to a reference value, which is stored together with the program code of the error-detection routines. If a discrepancy occurs in this comparison, the execution unit whose result led to a discrepancy in the comparison is labeled as faulty, and the step 550 is executed next. If no discrepancy occurs, step 510 is restarted, this time with new program segments or instructions and/or data.

In step 550, the execution units that are labeled as faulty and the comparator unit are deactivated. An execution unit may be shut down, for example, by not supplying any instructions, data, and/or clock signals to this execution unit, or by interrupting the connection of this execution unit to the comparator unit and to the system interface or to the data/address bus.

In step 560, the processor system continues to operate with the remaining non-faulty execution units. In a processor system having two execution units, this means a single-core operation. This is temporally restricted in safety-related systems.

In step 570, the processor system is shut down or switched to a defined secure state after a shutdown condition has been reached, for example, after exceeding a time limit for single-core operation.

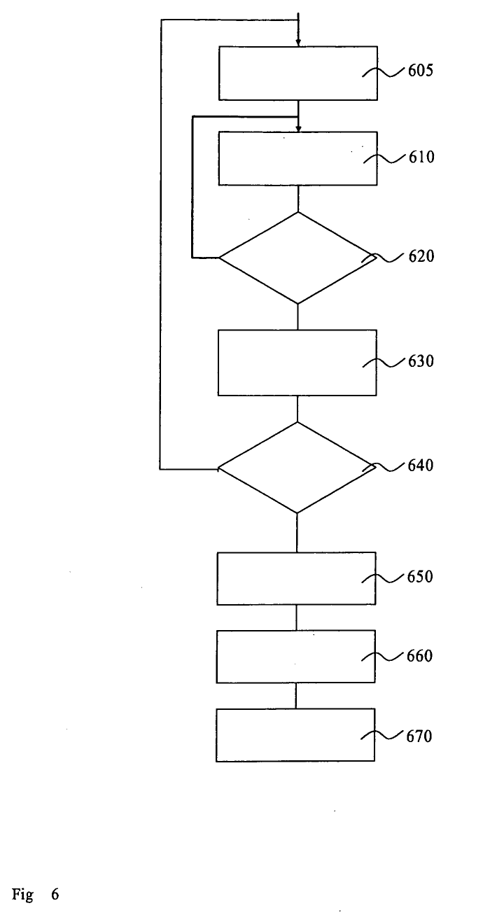

In FIG. 6, an additional method for controlling a processor system after the occurrence of a discrepancy among the output signals of the execution units is described by way of example.

In step 605, the master function is switched from a first to a second execution unit.

In step 610, the same instructions or program segments are processed in at least two execution units.

In step 620, the output signals of these at least two execution units are compared for consistency. If the output signals are identical or within a defined tolerance range, step 610 is restarted, this time with new program segments or instructions and/or data. If a discrepancy of the output signals is detected in step 620, step 630 is executed next.

In step 630, the processing of the current program sequence is continued on at least one of the execution units, but at least on the execution unit that is connected to the system interface or the data/address bus. An error-detection routine is carried out on at least one other execution unit. For this purpose, the comparator unit must be deactivated.

In step 640, the results of the error-detection routines are each compared to a reference value, which is stored together with the program code of the error-detection routines. If a discrepancy occurs in this comparison, the execution unit whose result led to a discrepancy during the comparison is labeled as faulty, and the step 650 is executed next. If no discrepancy occurs, step 605 is restarted, this time with new program segments or instructions and/or data.

In step 650, the execution units that are labeled as faulty are shut down. This may be carried out, for example, by not supplying any instructions, data, and/or clock signals to this execution unit, or by interrupting the connection of this execution unit to the comparator unit and to the system interface or to the data/address bus.

In step 660, the processor system continues to operate with the remaining non-faulty execution units. In a processor system having two execution units, this means a single-core operation. This is temporally restricted in safety-related systems.

In step 670, the processor system is shut down or switched to a defined secure state after a shutdown condition has been reached, for example, after exceeding a time limit for the single-core operation.

1-14. (canceled)

15. A method for controlling a computer system having at least two execution units and one comparator unit, the method comprising:
operating the at least two execution units in lockstep;
comparing results of at least two execution units; and
processing an error-detection mechanism on at least one execution unit for this execution unit, when or after the comparison unit detects an error.

16. The method of claim 15, wherein, when or after an error is detected by the comparator unit, a current instruction sequence on the at least two execution units is terminated and an error-detection mechanism is processed on the at least two execution units.

17. The method of claim 15, wherein, when or after an error is detected by the comparator unit, a current instruction sequence is terminated on only one of the execution units, on which an error-detection mechanism is processed, and wherein the comparator unit of at least two execution units is switched off for a duration of the processing of the error-detection mechanism, and the normal program sequence on the at least one other execution unit is further processed.

18. The method of claim 16, wherein after processing the error-detection mechanism, a normal program sequence is continued if the error-detection mechanism has not detected an error.

19. The method of claim 16, wherein, when or after an error is located on an execution unit, the faulty execution unit is shut down.

20. The method of claim 19, wherein the comparator unit is deactivated.

21. The method of claim 19, wherein when at least one component is deactivated, an error signal is generated and provided to the application.

22. The method of claim 15, wherein after an error occurs, the operation using only one of the execution units is restricted temporally, and the computer system is shut down no later than after a previously specified time has passed.

23. The method of claim 22, wherein the shutdown is already shut down before a previously specified time has passed by a signal generated by the application.

24. A device for controlling a computer system, comprising:
at least two execution units; and
a comparator unit, which is operated in lockstep with the at least two execution units, to compare results of the at least two execution units;
wherein, when or after an error has been detected by the comparator unit, an error-detection mechanism is processed on at least one of the execution units for this execution unit.

25. The device of claim 24, wherein the coupling of the lock step of the at least two execution units is canceled and the master function is assigned to any one execution unit.

26. The device of claim 24, wherein an error-detection is stored for the execution units.

27. The device of claim 24, wherein the at least one of the instructions and the program for the error-detection mechanism are supplied to at least one execution unit when required.

28. The device of claim 24, wherein the comparator unit is deactivatable.
